(19) United States
(12) Patent Application Publication
(10) Pub. No.: US 2017/0081960 A1
(43) Pub. Date: Mar. 23, 2017

(54) TURBINE AIRFOIL COOLING SYSTEM WITH PLATFORM COOLING CHANNELS

(71) Applicant: Siemens Energy, Inc., Orlando, FL (US)

(72) Inventors: Ching-Pang Lee, Cincinnati, OH (US); Ralph W. Matthews, Oviedo, FL (US); Nan Jiang, Charlotte, NC (US); Gm Salam Azad, Oviedo, FL (US)

(21) Appl. No.: 15/303,569

(22) PCT Filed: Jun. 5, 2014
(86) PCT No.: PCT/US2014/041017

§ 371 Date: Oct. 12, 2016

(51) Int. Cl. F01D 5/18

(52) U.S. Cl. CPC F01D 5/186; F05D 2260/202

(57) ABSTRACT

A cooling system (10) positioned within a turbine airfoil (12) useable in a turbine engine and having cooling channels (16) positioned within a platform (18) of the turbine airfoil (12) with exhaust outlets (20) at the pressure and suction side edges (22, 24) to prevent hot gas ingestion under the platform (18) is disclosed. The cooling channels (16) may be formed from main channels (26) extending from cooling fluid supply channels (64) aligned with the airfoil (12) and branch channels (30) extending between the main channels (26) and the pressure or suction side edges (22, 24). The cooling system (10) reduces the cooling surface area adjacent to the airfoil fillet (32) at the intersection (34) of the platform (18) and airfoil (12) and increases cooling surface area adjacent to the pressure side and suction side mate faces (22, 24) as compared with conventional designs. Such configuration of the cooling system (10) yields a more uniform platform temperature distribution, colder and higher pressure cooling air for platform cooling and less manufacturing expense than conventional designs.

### FIELD OF THE INVENTION

This invention is directed generally to turbine airfoils, and more particularly to cooling systems in platforms of hollow turbine airfoils usable in turbine engines.

### BACKGROUND

Typically, gas turbine engines include a compressor for compressing air, a combustor for mixing the compressed air with fuel and igniting the mixture, and a turbine blade assembly for producing power. Combustors often operate at high temperatures that may exceed 2,500 degrees Fahrenheit. Typical turbine combustor configurations expose turbine blade assemblies to these high temperatures. As a result, turbine blades must be made of materials capable of withstanding such high temperatures. In addition, turbine blades often contain cooling systems for prolonging the life of the blades and reducing the likelihood of failure as a result of excessive temperatures.

Typically, turbine blades are formed from a root portion having a platform at one end and an elongated portion forming a blade that extends outwardly from the platform coupled to the root portion. The blade is ordinarily composed of a tip opposite the root section, a leading edge, and a trailing edge. The inner aspects of most turbine blades typically contain an intricate maze of cooling channels forming a cooling system. The cooling channels in a blade receive air from the compressor of the turbine engine and pass the air through the blade. Some of the cooling fluids are passed through the root and into the cavity between adjacent turbine blades to cool the platforms of the blades. The cooling fluids may be exhausted through gaps between adjacent blades and may create film cooling. The gaps are typically formed between side surfaces of the platforms that are generally parallel to each other and parallel to a longitudinal axis of the turbine blade. These gaps are typically the location of hot gas ingestion into the area radially inward of the platforms when sufficient cooling air is not supplied to prevent hot gas ingestion. In addition, oxidation and erosion of the side surfaces of the platforms often occurs and results in a greater hot gas ingestion through the gap. Thus, a need exists for improving the cooling of the platforms for a more uniform thermal gradient and for reducing hot gas ingestion through the gaps between adjacent platforms of airfoils.

### SUMMARY OF THE INVENTION

A cooling system positioned within a turbine airfoil useable in a turbine engine and having cooling channels positioned within a platform of the turbine airfoil with exhaust outlets at the pressure and suction side edges to prevent hot gas ingestion under the platform is disclosed. The cooling channels may be formed from main channels extending from cooling fluid supply channels aligned with the airfoil and branch channels extending between the main channels and the pressure or suction side edges. The cooling system may reduce the cooling surface area adjacent to the airfoil fillet at an intersection of the platform and airfoil and increases cooling surface area adjacent to the pressure side and suction side mate faces as compared with conventional designs. Such configuration of the cooling system yields a more uniform platform temperature distribution, colder and higher pressure cooling air for platform cooling and less manufacturing expense than conventional designs.

In at least one embodiment, the turbine airfoil may be formed from a generally elongated, hollow airfoil having a leading edge, a trailing edge, a tip section at a first end, a root coupled to the airfoil at an end generally opposite the first end for supporting the airfoil and for coupling the airfoil to a disc, and a cooling system formed from at least one cavity in the elongated, hollow airfoil. A platform may be positioned at an intersection of the generally elongated, hollow airfoil and the root, wherein the platform includes an upstream edge, a downstream edge opposite the upstream edge, a pressure side edge positioned proximate to a pressure side of the generally elongated, hollow airfoil and a suction side edge positioned proximate to a suction side of the generally elongated, hollow airfoil.

At least a portion of the cooling system may be positioned within the platform and formed from one or more pressure side main cooling channels extending from an inlet at a cooling fluid supply channel to an exhaust outlet at the pressure side edge. The cooling system may also include one or more pressure side branch cooling channels extending from an inlet in the pressure side main cooling channel to an exhaust outlet at the pressure side edge. The pressure side branch cooling channel may have a smaller cross-sectional area than a cross-sectional area of the at least one pressure side main cooling channel.

The pressure side branch cooling channel may extend from a downstream side of the at least one pressure side main cooling channel. The exhaust outlet of the pressure side branch cooling channel may be positioned downstream from the exhaust outlet of the pressure side main cooling channel. The pressure side branch cooling channel may extend nonorthogonally from and nonparallel to a downstream side of the pressure side main cooling channel. The pressure side branch cooling channel include a plurality of pressure side branch cooling channels extending from a first pressure side main cooling channel. The plurality of pressure side branch cooling channels may be parallel to each other. The pressure side main cooling channel may include a plurality of pressure side main cooling channels, wherein each of the plurality of pressure side main cooling channels has at least two pressure side branch cooling channels extending from the pressure side main cooling channel to the pressure side edge.

The cooling system may also include one or more suction side main cooling channels extending from an inlet at a cooling fluid supply channel to an exhaust outlet at the suction side edge. One or more suction side branch cooling channels may extend from an inlet in the suction side main cooling channel to an exhaust outlet at the suction side edge. The suction side branch cooling channel may have a smaller cross-sectional area than a cross-sectional area of the at least one suction side main cooling channel. The suction side branch cooling channel may extend from a downstream side of the suction side main cooling channel. The exhaust outlet of the suction side branch cooling channel may be positioned downstream from the exhaust outlet of the suction side main cooling channel. The suction side branch cooling channel may extend nonorthogonally from and nonparallel to a downstream side of the suction side main cooling channel. The suction side branch cooling channel may include a plurality of suction side branch cooling channels extending from a first suction side main cooling channel of the suction side main cooling channel. The plurality of suction side branch cooling channels may be parallel to each other. The suction side main cooling channel may include one or more upstream side branch cooling channels extending from an upstream side of the suction side main cooling channel and one or more downstream side branch cooling channels extending from a downstream side of the suction side main cooling channel. The upstream side branch cooling channel extending from an upstream side of the suction side main cooling channel may have an exhaust outlet on the suction side edge, and the downstream side branch cooling channel extending from a downstream side of the suction side main cooling channel may have an exhaust outlet on a downstream edge of the platform. The inlet of the suction side main cooling channel may be positioned upstream of the exhaust outlet at the suction side edge.

The cooling system may also include one or more trailing edge main cooling channels extending from a cooling fluid supply channel proximate to the trailing edge and including at least one pressure side branch channel extending from an inlet at the trailing edge main cooling channel and terminating at an outlet at the pressure side edge. The trailing edge main cooling channel may also include one or more trailing edge branch channels extending from an inlet at the trailing edge main cooling channel and terminating at an outlet at the downstream edge of the platform. The pressure side branch channel may include a plurality of pressure side branch channels extending from the trailing edge main cooling channel to the pressure side edge, and the trailing edge branch channel may include a plurality of trailing edge branch channels extending from the trailing edge main cooling channel to the downstream edge of the platform.

An advantage of the cooling system is that the cooling system may reduce the cooling surface area adjacent to the airfoil fillet at an intersection of the platform and airfoil.

Another advantage of the cooling system is the cooling system may increase cooling surface area adjacent to the pressure side and suction side mate faces as compared with conventional designs.

Yet another advantage of the cooling system is that the cooling system yields a more uniform platform temperature distribution, colder and higher pressure cooling air for platform cooling and less manufacturing expense than conventional designs.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a perspective view of a suction side of a turbine airfoil having features of the cooling system.

FIG. 2 is a perspective view of a pressure side of a turbine airfoil having features of the cooling system.

FIG. 3 is a cross-sectional view of the cooling system in the platform of the airfoil taken at section line 3-3 in FIG. 1.

### DETAILED DESCRIPTION OF THE INVENTION

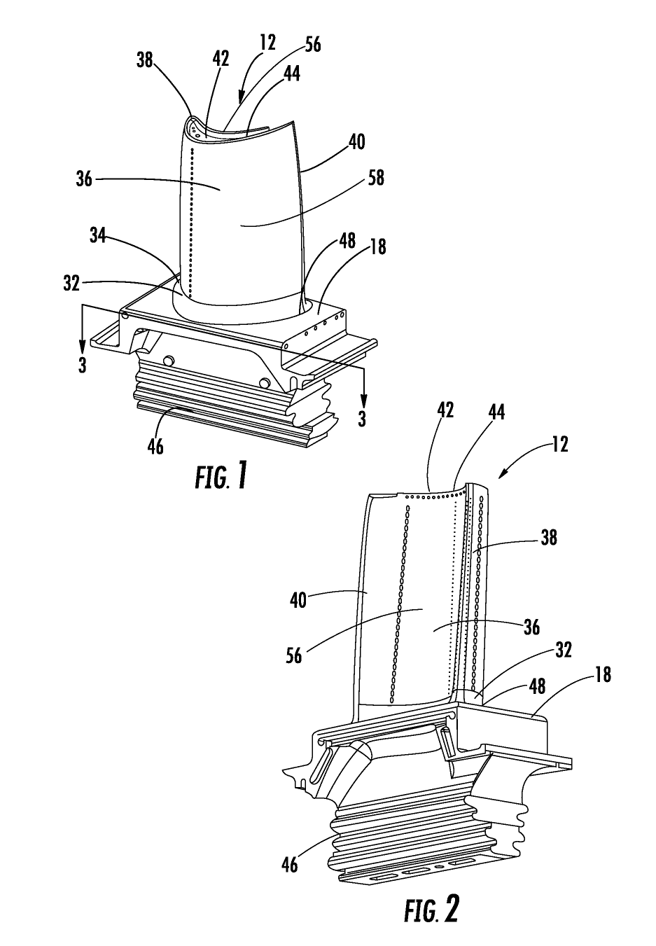

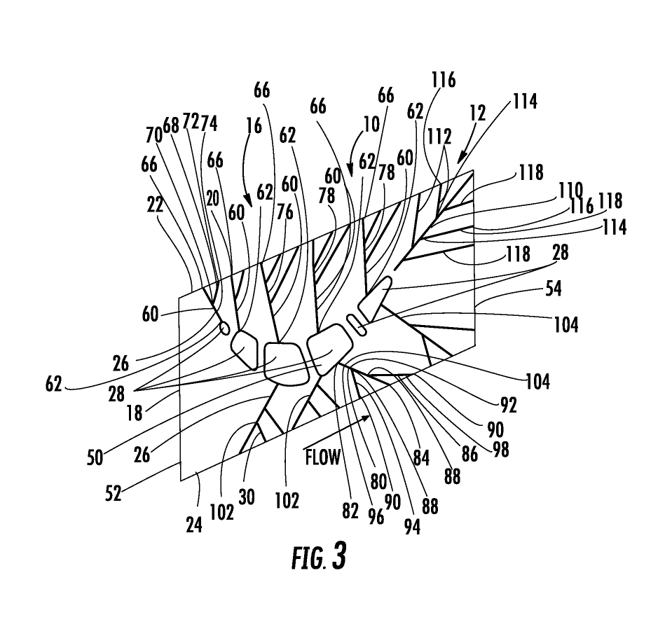

As shown in FIGS. 1-3, a cooling system 10 positioned within a turbine airfoil 12 useable in a turbine engine and having cooling channels 16 positioned within a platform 18 of the turbine airfoil 12 with exhaust outlets 20 at the pressure and suction side edges 22, 24 to prevent hot gas ingestion under the platform 18 is disclosed. The cooling channels 16 may be formed from main channels 26 extending from cooling fluid supply channels 28 aligned with the airfoil 12 and branch channels 30 extending between the main channels 26 and the pressure or suction side edges 22, 24. The cooling system 10 may reduce the cooling surface area adjacent to the airfoil fillet 32 at an intersection 34 of the platform 18 and airfoil 12 and increases cooling surface area adjacent to the pressure side and suction side mate faces 22, 24 as compared with conventional designs. Such configuration of the cooling system 10 yields a more uniform platform temperature distribution, colder and higher pressure cooling air for platform cooling and less manufacturing expense than conventional designs.

In at least one embodiment, the turbine airfoil 12 may be formed from a generally elongated, hollow airfoil 36 having a leading edge 38, a trailing edge 40, a tip section 42 at a first end 44, a root 46 coupled to the airfoil 36 at a second end 48 generally opposite to the first end 44 for supporting the airfoil 36 and for coupling the airfoil 36 to a disc, and the cooling system 10 formed from at least one cavity 50 in the elongated, hollow airfoil 36. The platform 18 may be positioned at the intersection 34 of the generally elongated, hollow airfoil 36 and the root 46. The platform 18 may include an upstream edge 52, a downstream edge 54 opposite the upstream edge 52, a pressure side edge 22 positioned proximate to a pressure side 56 of the generally elongated, hollow airfoil 36 and a suction side edge 24 positioned proximate to a suction side 58 of the generally elongated, hollow airfoil 36. The turbine airfoil 12 may have any appropriate shape and configuration.

At least a portion of the cooling system 10 may be positioned within the platform 18, as shown in FIG. 3, and formed from one or more pressure side main cooling channels 60 extending from an inlet 62 at a cooling fluid supply channel 28 to an exhaust outlet 66 at the pressure side edge 22. The cooling fluid supply channel 28 may extend generally spanwise into the generally elongated, hollow airfoil 36. The cooling system 10 may include one or more pressure side branch cooling channels 68 extending from an inlet 70 in the pressure side main cooling channel 60 to an exhaust outlet 72 at the pressure side edge 22. The pressure side branch cooling channel 68 may have a smaller cross-sectional area than a cross-sectional area of the pressure side main cooling channel 60. In another embodiment, the pressure side branch cooling channel 68 may have a cross-sectional area equal to a cross-sectional area of the pressure side main cooling channel 60. The pressure side main cooling channel 60 and the pressure side branch cooling channel 68 may have any appropriate shape, length and configuration. In at least one embodiment, a length of the pressure side branch cooling channel 68 may be shorter than a length of the pressure side main cooling channel 60. The pressure side branch cooling channel 68 may be about ½ as long as a length of the pressure side main cooling channel 60. In yet another embodiment, the pressure side branch cooling channel 68 may be about ¼ as long as a length of the pressure side main cooling channel 60.

The pressure side branch cooling channel 68 may extend from a downstream side 74 of the pressure side main cooling channel 60. The exhaust outlet 72 of the pressure side branch cooling channel 68 may be positioned downstream from the exhaust outlet 66 of the pressure side main cooling channel 60. The pressure side branch cooling channel 68 may extend nonorthogonally from and nonparallel to the downstream side 74 of the pressure side main cooling channel 60. In at least one embodiment, the cooling system 10 may include a plurality of pressure side branch cooling channels 68 extending from a first pressure side main cooling channel 60. Two or more of the plurality of pressure side branch cooling channels 68 may be parallel to each other. In at least one embodiment, each of the plurality of pressure side main cooling channels 60 may have at least two pressure side branch cooling channels 68 extending from the pressure side main cooling channel 60 to the pressure side edge 22. More specifically, at least three pressure side main cooling channels 60 may be positioned upstream of the exhaust outlets 72 at the pressure side edge 22. These pressure side main cooling channels 60 may be positioned upstream of two pressure side main cooling channels 78 having exhaust outlets 66 positioned downstream of the inlets 62.

The cooling system 10 may also include one or more suction side main cooling channels 80 extending from an inlet 82 at a cooling fluid supply channel 28 to an exhaust outlet 84 at the suction side edge 24. One or more suction side branch cooling channels 86 may extend from an inlet 88 in the suction side main cooling channel 80 to an exhaust outlet 90 at the suction side edge 24. The suction side branch cooling channel 86 may have a smaller cross-sectional area than a cross-sectional area of the suction side main cooling channel 80. In another embodiment, the suction side branch cooling channels 86 may have a cross-sectional area equal to a cross-sectional area of the suction side main cooling channels 80. The suction side main cooling channels 80 and the suction side branch cooling channels 86 may have any appropriate shape, length and configuration. In at least one embodiment, a length of the suction side branch cooling channels 86 may be shorter than a length of the suction side main cooling channels 80. The suction side branch cooling channels 86 may be about ½ as long as a length of the suction side main cooling channels 80. In yet another embodiment, the suction side branch cooling channels 86 may be about ¼ as long as a length of the suction side main cooling channels 80.

The suction side branch cooling channel 86 may extend from a downstream side 92 of the suction side main cooling channel 80. The exhaust outlet 90 of the suction side branch cooling channel 86 may be positioned downstream from the exhaust outlet 84 of the suction side main cooling channel 80. The suction side branch cooling channel 86 may extend nonorthogonally from and nonparallel to the downstream side 92 of the suction side main cooling channel 80. The cooling system 10 may include a plurality of suction side branch cooling channels 86 extending from a suction side main cooling channel 80. In at least one embodiment, the plurality of suction side main cooling channels 80 may each include at least two suction side branch cooling channels 86 extending from the suction side main cooling channel 80 to the suction side edge 24. The suction side branch cooling channels 86 may be parallel to each other. The suction side main cooling channel 80 may include one or more upstream side branch cooling channels 94 extending from an upstream side 96 of the suction side main cooling channel 80 and one or more downstream side branch cooling channels 98 extending from the downstream side 92 of the suction side main cooling channel 80. The upstream side branch cooling channel 94 extending from the upstream side 96 of the suction side main cooling channel 80 may include an exhaust outlet 90 on the suction side edge 24, and the downstream side branch cooling channel 98 extending from the downstream side 92 of the suction side main cooling channel 80 may have an exhaust outlet 90 on a downstream edge 54 of the platform 18. In at least one embodiment, a plurality of suction side main cooling channels 80 may include upstream side branch cooling channels 94 and downstream side branch cooling channels 98. In at least one embodiment, the exhaust outlet 84 of the suction side main cooling channel 80 may be positioned upstream of the exhaust outlet 90 at the suction side edge 24. More specifically, two suction side main cooling channels 102 may be positioned upstream of the exhaust outlet 84 at the suction side edge 24. These suction side main cooling channels 102 may be positioned upstream of two suction side main cooling channels 104 having exhaust outlets 84 positioned downstream of the inlets 82.

The cooling system 10 may also include a trailing edge main cooling channel 110 extending from a cooling fluid supply channel 28 proximate to the trailing edge 40 and including one or more pressure side branch channels 112 extending from an inlet 114 at the trailing edge main cooling channel 110 and terminating at an outlet 116 at the pressure side edge 22. The trailing edge main cooling channel 110 may also include one or more trailing edge branch channels 118 extending from an inlet 114 at the trailing edge main cooling channel 110 and terminating at an outlet 116 at the downstream edge 54 of the platform 18. The tailing edge main cooling channel 110 may include a plurality of pressure side branch channels 112 extending from the trailing edge main cooling channel 110 to the pressure side edge 22. The tailing edge main cooling channel 110 may include a plurality of trailing edge branch channels 118 extending from the trailing edge main cooling channel 110 to the downstream edge 54 of the platform 18.

During use, cooling fluids may be supplied from a compressor or other cooling fluid source to the cooling channels 16 within the generally elongated hollow airfoil 36. The cooling fluids may then flow into the pressure side main cooling channels 60, the suction side main cooling channels 80 and the trailing edge main cooling channel 110. The air flowing through these channels increase in temperature, thereby cooling the platform 18. The air then flows into the pressure side branch cooling channels 68, the suction side branch cooling channels 86 and the trailing edge branch channels 118, there the air flowing through these channels continues to increase in temperature, thereby further cooling the platform 18. The air is exhausted at the pressure and suction side edges 22, 24 and the downstream edge 54 where the cooling air prevents ingestion of hot gas path air beneath the platform.

The foregoing is provided for purposes of illustrating, explaining, and describing embodiments of this invention. Modifications and adaptations to these embodiments will be apparent to those skilled in the art and may be made without departing from the scope or spirit of this invention.

1. A turbine airfoil comprising:
a generally elongated, hollow airfoil having a leading edge, a trailing edge, a tip section at a first end, a root coupled to the airfoil at an end generally opposite the first end for supporting the airfoil and for coupling the airfoil to a disc, and a cooling system formed from at least one cavity in the elongated, hollow airfoil;
a platform positioned at an intersection of the generally elongated, hollow airfoil and the root, wherein the platform includes an upstream edge, a downstream edge opposite the upstream edge, a pressure side edge positioned proximate to a pressure side of the generally elongated, hollow airfoil and a suction side edge positioned proximate to a suction side of the generally elongated, hollow airfoil; and
wherein at least a portion of the cooling system is positioned within the platform and formed from at least one pressure side main cooling channel extending from an inlet at a cooling fluid supply channel to an exhaust outlet at the pressure side edge;
at least one pressure side branch cooling channel extending from an inlet in the at least one pressure side main cooling channel to an exhaust outlet at the pressure side edge;
wherein the at least one pressure side branch cooling channel has a smaller cross-sectional area than a cross-sectional area of the at least one pressure side main cooling channel;
at least one suction side main cooling channel extending from an inlet at a cooling fluid supply channel to an exhaust outlet at the suction side edge;
at least one suction side branch cooling channel extending from an inlet in the at least one suction side main cooling channel to an exhaust outlet at the suction side edge, and
wherein the at least one suction side branch cooling channel has a smaller cross-sectional area than a cross-sectional area of the at least one suction side main cooling channel.

2. The turbine airfoil of claim 1, wherein the at least one pressure side branch cooling channel extends from a downstream side of the at least one pressure side main cooling channel.

3. The turbine airfoil of claim 1, wherein the exhaust outlet of the at least one pressure side branch cooling channel is positioned downstream from the exhaust outlet of the at least one pressure side main cooling channel.

4. The turbine airfoil of claim 1, wherein the at least one pressure side branch cooling channel extends nonorthogonally from and nonparallel to a downstream side of the at least one pressure side main cooling channel.

5. The turbine airfoil of claim 1, wherein the at least one pressure side branch cooling channel comprises a plurality of pressure side branch cooling channels extending from a first pressure side main cooling channel of the at least one pressure side main cooling channel.

6. The turbine airfoil of claim 5, wherein the plurality of pressure side branch cooling channels are parallel to each other.

7. The turbine airfoil of claim 1, wherein the at least one pressure side main cooling channel comprises a plurality of pressure side main cooling channels, wherein each of the plurality of pressure side main cooling channels has at least two pressure side branch cooling channels extending from the pressure side main cooling channel to the pressure side edge.

8. The turbine airfoil of claim 1, wherein the at least one suction side branch cooling channel extends from a downstream side of the at least one suction side main cooling channel.

9. The turbine airfoil of claim 1, wherein the exhaust outlet of the at least one suction side branch cooling channel is positioned downstream from the exhaust outlet of the at least one suction side main cooling channel.

10. The turbine airfoil of claim 1, wherein the at least one suction side branch cooling channel extends nonorthogonally from and nonparallel to a downstream side of the at least one suction side main cooling channel.

11. The turbine airfoil of claim 1, wherein the at least one suction side branch cooling channel comprises a plurality of suction side branch cooling channels extending from a first suction side main cooling channel of the at least one suction side main cooling channel.

12. The turbine airfoil of claim 11, wherein the plurality of suction side branch cooling channels are parallel to each other.

13. The turbine airfoil of claim 1, wherein the at least one suction side main cooling channel includes at least one upstream side branch cooling channel extending from an upstream side of the at least one suction side main cooling channel and at least one downstream side branch cooling channel extending from a downstream side of the at least one suction side main cooling channel.

14. The turbine airfoil of claim 1, wherein the at least one suction side main cooling channel includes at least one upstream side branch cooling channel extending from an upstream side of the at least one suction side main cooling channel and having an exhaust outlet on the suction side edge and at least one downstream side branch cooling channel extending from a downstream side of the at least one suction side main cooling channel and having an exhaust outlet on a downstream edge of the platform.

15. The turbine airfoil of claim 1, wherein the inlet of the at least one suction side main cooling channel is positioned upstream of the exhaust outlet at the suction side edge.

16. The turbine airfoil of claim 1, further comprising a trailing edge main cooling channel extending from a cooling fluid supply channel proximate to the trailing edge and including at least one pressure side branch channel extending from an inlet at the trailing edge main cooling channel and terminating at an outlet at the pressure side edge and including at least one trailing edge branch channel extending from an inlet at the trailing edge main cooling channel and terminating at an outlet at the downstream edge of the platform.

17. The turbine airfoil of claim 16, wherein the at least one pressure side branch channel comprises a plurality of pressure side branch channels extending from the trailing edge main cooling channel to the pressure side edge, and wherein the at least trailing edge branch channel comprises a plurality of trailing edge branch channels extending from the trailing edge main cooling channel to the downstream edge of the platform.
